(19) United States
(12) Patent Application Publication
(10) Pub. No.: US 2026/0021786 A1
(43) Pub. Date: Jan. 22, 2026

(54) TRAILER LOCK

(71) Applicant: Dennis L. Anthony, Lawrence, KS (US)

(72) Inventor: Dennis L. Anthony, Lawrence, KS (US)

(21) Appl. No.: 18/780,062

(22) Filed: Jul. 22, 2024

(51) Int. Cl. B60R 25/00

(52) U.S. Cl. CPC B60R 25/001

(57) ABSTRACT

The present invention is directed towards an improved trailer locking device configured for association with a trailer and a corresponding method of operation wherein movement of an associated trailer is limited by extending an extendable support at least partially received by a receiver having a complementary cross-section configured for slidable receipt of the extendable support, a fastening pin configured for at least partial passage through at least one side of the receiver and at least partially though the extendable support, the fastening mechanism being configured for engagement with the fastening pin, an upper support spaced from a lower support and configured for mounting the receiver in a vertical position and a security plate mounted on the receiver and configured to at least partially obscure the fastening pin.

### FIELD OF THE INVENTION

The current invention is related to locking devices and more specifically to a rear fender mounted trailer locking device which inhibits attachment to the trailer coupler limiting movement of the trailer.

### BACKGROUND OF THE INVENTION

Trailers such as small enclosed utility trailers, flatbed or open trailers, travel trailers and recreational vehicle trailers, towable RVs and camping trailers and equipment trailers for hauling construction equipment, landscaping tools are used to transport valuable equipment, tools, personal belongings which are susceptible to theft. Many of these trailers include a mating feature that can engage with and disengage from a corresponding mating feature on a pulling vehicle. For example, trailers for use with a truck typically include a trailer coupler with a receiver for receiving a trailer ball which is mounted to a ball mount on the underside of the truck or other vehicle via a hitch pin or trailer hitch, for example.

Many of the smaller utility, recreational trailers and open trailers are targeted by thieves because of their mobility, versatility quick loading times and valuable contents. To prevent the theft of a trailer when it is not engaged with a vehicle, anti-theft devices may be used. Current anti-theft devices often consist of a various mechanical locking devices like a coupler lock, a tongue lock, a hitch lock, wheel clamps, wheel locks, brake locks, GPS Trackers, Alarms and chains and straps for securing the trailer to an immovable object like a post or tree. Often these locking devices include a padlock or metal sleeve mounted directly on the trailer coupler on the trailer to prevent the trailer from fitting into a receiver of an unauthorized vehicle. The locking device may include a lock on the trailer coupler or a sleeve to go over the opening on the coupler.

Other attempts to prevent the theft include a locking mechanism such as a hitch pin lock to prevent the socket portion of the trailer hitch from being attached to a ball portion of an unauthorized vehicle or trailer hitch or from being clamped to another ball or attached to the towable device's tongue receiver. Other attempts include locking a trailer support on the front of the trailer to prevent it from raised or lowered for attachment of the trailer to an unauthorized towing vehicle.

In 2016 there were approximately 4,531 recreational vehicles stolen with 88% of those being towable trailers. On average 208 towable vehicles are stolen each month. Current mechanical locking devices are easily defeated since they can be easily cut or removed from the trailer or trailer hitch. Accordingly, the trailer is still susceptible to theft because the trailer locking devices are easily removed and the tongue is capable of being raised allowing the trailer to be moved. Further, a thief may also simply defeat the existing hitch lock (which is typically in the form of an exposed padlock) with a saw or other cutting device to gain access to the trailer and attach it to a towing vehicle. The prior art attempts to solve this problem have been insufficient.

Current anti-theft devices have several disadvantages. Some of these locking devices can be easily removed or become dirty, greasy, and difficult to use. Further, the effort required to deploy many current anti-theft devices for trailers can discourage their use, which can leave trailers exposed to theft. For example sleeve-style locks which attach to the hitch, typically require a user to crawl underneath the trailer to mount the sleeve on the hitch under trailers which may be dirty and muddy to mount the locking device or release the locking device, which in turn can result in injuries.

Those problems and others are not only present in current trailer locks, but among many different kinds of trailers and trailer locks. For this reason, it would be beneficial to provide an improved trailer lock which provides for a trailer attached extendable support for rotation of the trailer tongue, the extendable support being fixed to a trailer sidewall and trailer which includes a locking mechanism to inhibit the unauthorized adjustment of the extendable support.

Therefore, in view of the prior art, there exists a need for devices and methods for the improved trailer lock which is configured for rotation of a trailer between a movable position with the improved trailer lock retracted and a parked position with the improved trailer lock in the extended position, the improved trailer lock being selectively adjustable as desired to at least in part address some of the aforementioned problems. The devices and methods of the present invention address these and other needs that will become apparent to those skilled in the art based on the following specification and the accompanying drawings.

### SUMMARY OF THE INVENTION

An improved trailer lock for use with a trailer having a sidewall extending upwardly from a support member extending from a tongue, said trailer lock comprising at least one extendable support leg, a receiver configured for slidable receipt of one of said extendable support leg, at least one mounting bracket for mounting said receiver to at least one of said sidewall and said support member; a locking mechanism for adjustably securing said extendable support leg to said receiver, whereby operation of said extendable support leg rotates said trailer between a moveable orientation with said support member being horizontally orientated and a parked position with said tongue being rotated downward.

In an alternative embodiment, the present invention provides an improved trailer locking device configured for limiting movement of a trailer, said improved trailer locking device comprising an extendable support having a cross-section, a receiver having a complementary cross-section configured for slidable receipt of the extendable support, a fastening pin configured for at least partial passage through at least one side of said receiver and at least partially though the extendable support, the fastening mechanism being configured for engagement with the fastening pin, an upper support spaced from a lower support the upper and lower support being configured for mounting the receiver in a vertical position, one of the upper and lower support configured for vertical adjustment of the receiver, and a security plate mounted on said receiver and configured to at least partially obscure the fastening pin.

An exemplary method for locking a trailer having a support extending from a proximal end to a distal end, the method includes the steps of providing an improved locking device configured for attachment to the distal end of the trailer for communication with said support, the improved locking device comprising an extendable support, a receiver configured for slidable receipt of the extendable support, a fastening pin, a fastening mechanism configured for at least partial receipt of the fastening pin, an upper support and a lower support, configuring the upper support and the lower support for attaching the improved locking device near the distal end whereby the improved locking device is configured for rotation of the proximal end, extending the extendable support at least partially through the receiver whereby movement of the trailer is at least partially limited, aligning a pin receiver associated with the extendable support within the receiver for at least partial receipt of the fastening pin, extending the fastening pin at least partially through the receiver, securing the fastening pin at least partially by the fastening mechanism; and associating a shroud plate with the fastening mechanism wherein the shroud plate at least partially prevents damage to the improved locking device.

### BRIEF DESCRIPTION OF THE DRAWINGS

FIG. 1 is a perspective side view of the improved trailer lock in accordance with an embodiment of the present invention.

FIG. 2 is right-side perspective of the improved trailer lock in accordance with the embodiment depicted in FIG. 1.

FIG. 3 is right-side exploded view of the improved trailer lock in accordance with the embodiment depicted in FIG. 1.

FIG. 4 is side elevation an exemplary enclosed trailer in a horizontal orientation in accordance with an embodiment of the improved trailer lock in a retracted position for movement of the trailer in accordance with the embodiment depicted in FIG. 1.

FIG. 5 is side elevation an exemplary enclosed trailer in a horizontal orientation in accordance with an embodiment of the improved trailer lock in an extended position in accordance with the embodiment depicted in FIG. 1.

FIG. 6 is side elevation an exemplary enclosed trailer in a downward orientation in accordance with an embodiment of the improved trailer lock in an extended position for parking the trailer in accordance with the embodiment depicted in FIG. 1.

### DETAILED DESCRIPTION

Certain terminology will be used in the following description for convenience in reference only and will not be limiting. For example, top, bottom, front, back, right and left refer to the illustrated embodiment as oriented in the view being referred to. The words “upwardly” and “downwardly” refer to directions up or down and away from, respectively, the geometric center of the embodiment being described and designated parts thereof. As used herein, the term “elongate” shall be construed broadly to include structures that have one dimension, such as a length, that is greater than another dimension, such as a width or diameter. Such terminology will include the words specifically mentioned, derivatives thereof and words of similar meaning.

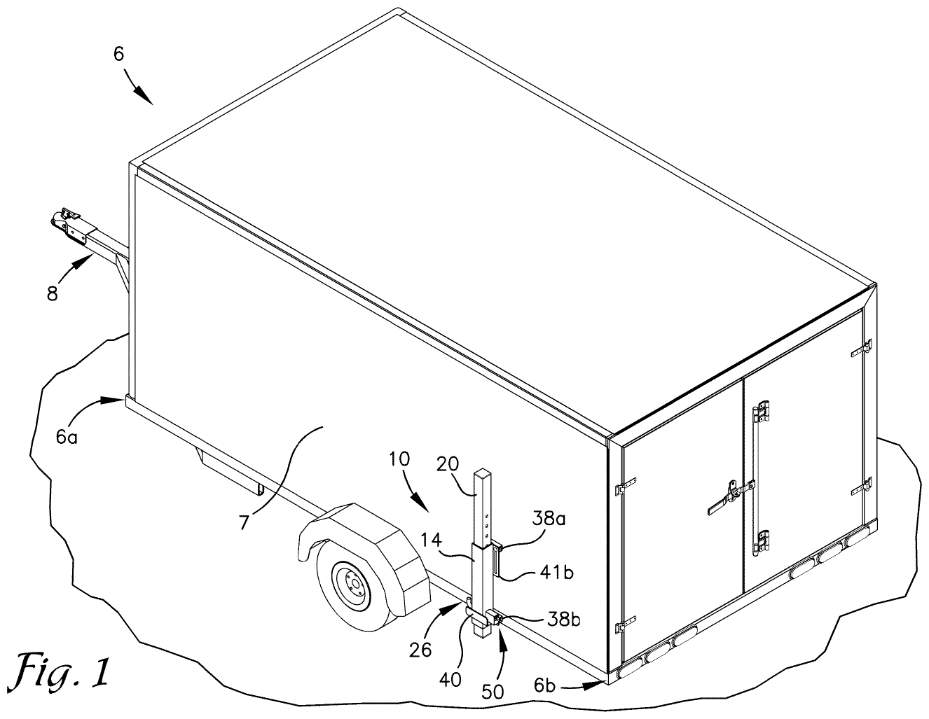

Referring to FIG. 1, the improved trailer lock is generally referred to by reference numeral 10 and in one embodiment is illustrated with a support leg 20 received by a receiver 14 mounted with at least one mounting bracket 30 to a sidewall 7 of the trailer 6 where the support leg 20 is secured in an extended positioned, also referred to as the parked position, for rotation of the trailer 6 with a fastening pin 26 which extends through opposite sides of the receiver 14 and the support leg 20 to a fastening pin receiver 28.

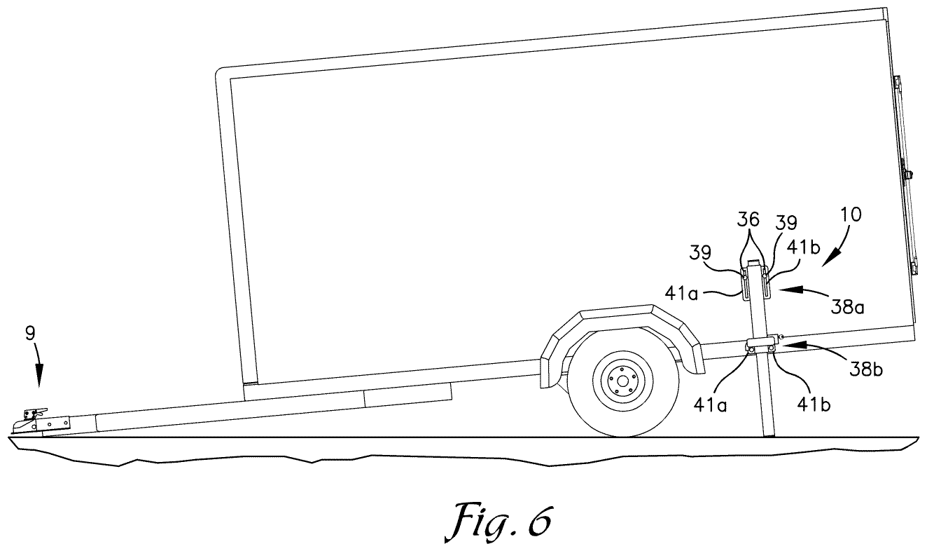

In one embodiment, the improved trailer lock 10 includes components which may be fabricated from metallic materials such as steel, aluminum, iron or synthetic or organic materials such as fiberglass, nylon, rubber or synthetic carbon fiber, or a combination of any of the above materials or a composite of the same or like qualities as would be reasonably understood by one of like skill. As illustrated in FIG. 6, in a parked position, with a coupler 9, also referred to as a hitch receiver, in a rotated downward position. In the parked position, the coupler 9 is difficult to access with a standard vehicle and thus, the trailer 6 is difficult to connect or move. In this way, the trailer in the parked position illustrated in FIG. 6 limits undesired movement of the trailer 6.

While FIG. 1 depicts a towed type of trailer 14, it is understood that trailer 14 may be utilized with any type of towing vehicle known in the art, such as a truck, tractor or car, or any other variety of on-road or off-road vehicle with a hitch for attaching to a ball socket on the tongue 8 of the trailer 14 or similar type of trailer connection known in the art, for example. Likewise, the principles of the present disclosure may be utilized with any variety of trailer 14 known in the art, such as camping trailers, boat trailers or cargo trailers, for example.

The trailer 6 depicted in FIG. 1 extends between a front 6a and a rear 6b with a tubular support member 4 extending therebetween. The tongue 8 extends from the front 6a and is configured to for attachment to the towing vehicle (not sown) with a hitch receiver 9, for example. Although other trailer embodiments may be utilized, the depicted embodiment of the trailer 6 is an enclosed trailer with a sidewall 7 extending circumferentially along and extending upwardly from the tubular support member 4.

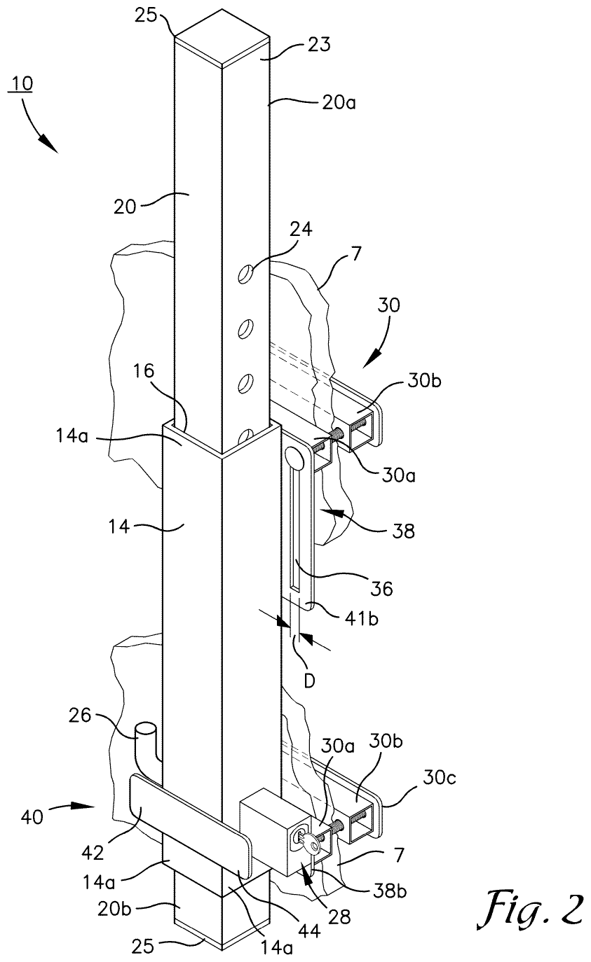

FIG. 2 provides a more detailed illustration of an embodiment of the improved locking device 10 with receiver 14 in receipt of the support leg 20. In the illustrated embodiment, the support leg 20 is a generally symmetrical rectangular tubing structure which extends between a distal end 20a and a proximate end 20b, the distal end 20a associated with a plurality of apertures 24 extending longitudinally along the outer support surface. It will be understood that the support leg 20 may have various different configurations and may be formed from elongated members having a rounded or rectangular cross-section or that the support leg 20 may have irregular or reduced shape along its length.

In one embodiment the tubular support member 20 includes at least one cap 25 covering at least one of the distal end 20a or the proximate end 20b. The cap 25 is configured to help protect the support leg 20 from tampering and from the elements and has a corresponding surface configuration. It will be understood that other embodiment of the cap may be provided including in one alternative embodiment, the cap 25 may be conically shaped. Additionally, the cap 25 may include a variety of electrical accessory items such as an illumination device, including an LED light for enhanced visibility, a GPS tracker for locating the trailer 6 or a visual recording device, such as a camera, for selectively recording the surrounding environment. Additionally, the cap 25 may include an integrated power source for powering the LED or visual recording device. In one embodiment, the cap 25 may be fabricated from a plastic, metal or composite material or may be fabricated from a combination of materials as would be reasonably understood by one of like skill.

The depicted embodiment of the support leg 20 generally has a rectangular cross-section with an elongated rectangular shaped tubing structure with at least a partially perforated outer sidewall 23 with the plurality of apertures 24 spaced along a portion of the outer sidewall 23. The rectangular-shaped elongated support leg 20 may provide enhanced stability but alternatively could be triangular, cylindrical, regular or irregularly shaped as desired.

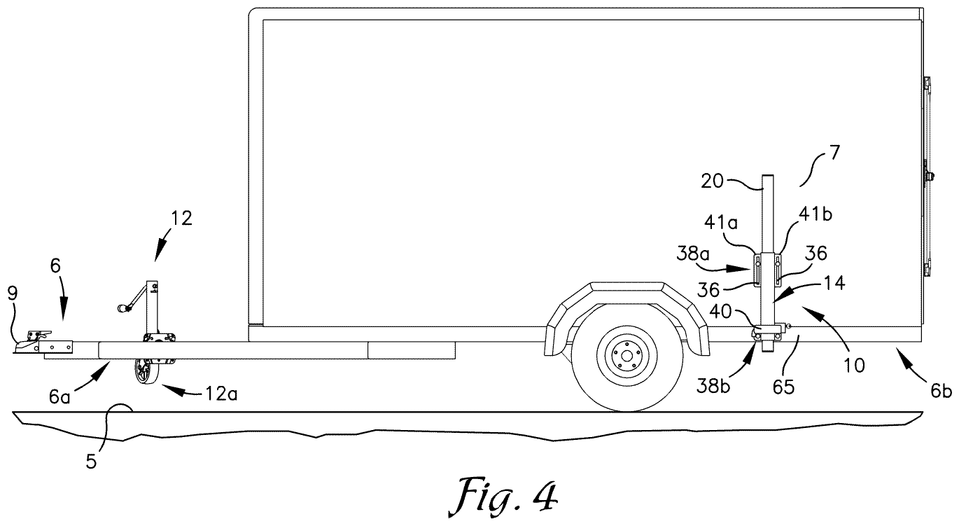

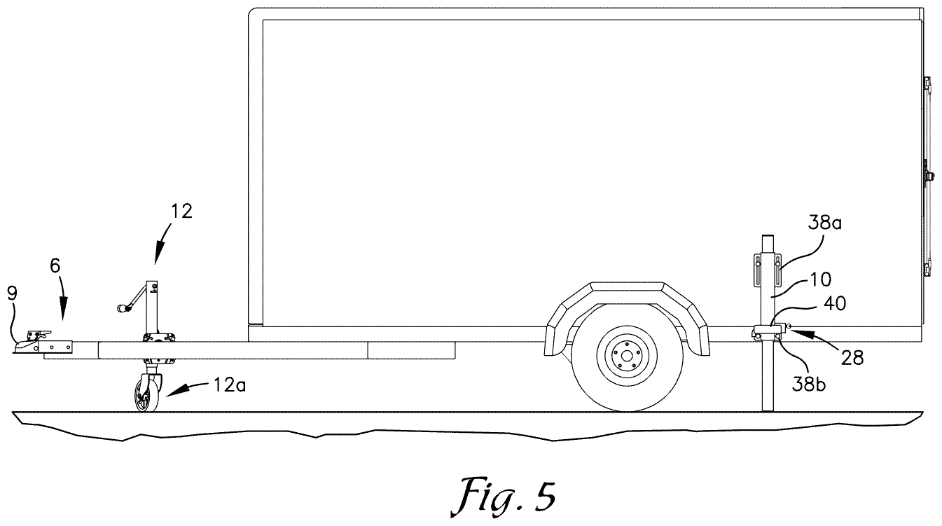

FIG. 4 illustrates an embodiment of the trailer 6 in a moveable position with the elongated support leg 20 in a raised position. FIG. 5 illustrates the trailer 6 transitioning from the moveable position of FIG. 4 to a parked position illustrated in FIG. 6 with the elongated support leg 20 extending downward towards the ground 5. As the lowered support leg 20 comes into contact with the ground 5, the trailer rear 6b is driven upward causing the tongue 8 to rotate downward. In the downward orientation, the connection to the coupler 9 is limited as a result of the downward rotation caused by the downward extension of the extendable support leg 20. Movement of the trailer 6 is limited while the extendable support leg 20 extends into the ground 5.

The embodiment of the receiver 14 depicted in FIG. 2 has a generally rectangular cross-section corresponding to the outer sidewall 23 of the support leg 20 with an inner sidewall 16 having an inner dimension greater than the outer sidewall 23 for slideable receipt of the support leg 20.

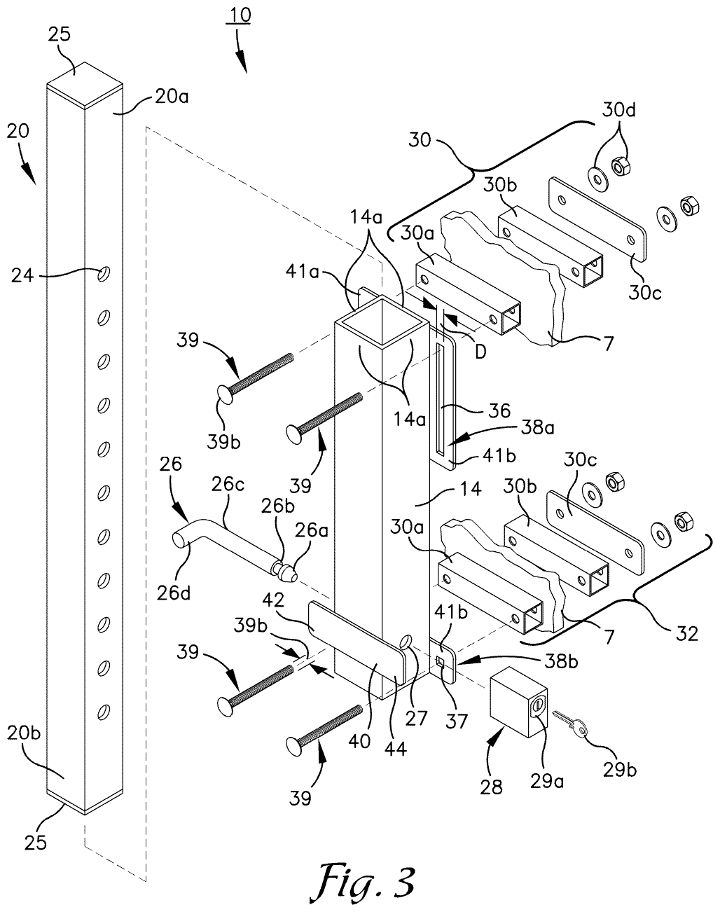

Generally, the receiver 14 includes at least a pair of symmetrically opposite sides 14a with a flange 38 with a proximate and distal flange end 41a, 41b for mounting the receiver 14 to the trailer 6 with a mounting bracket 30. As depicted in FIG. 3, the receiver 14 includes an upper flange 38a, and a lower flange 38b.

The depicted embodiment of the upper flange 38a in FIG. 3 is generally rectangularly planar and includes at least one elongated channel 36 spaced from at least one of the receiver sides 14a. In the depicted embodiment, the upper flange 38a extends outwardly from one side 14a presenting proximate flange end 41a and distal flange end 41b. As illustrated in FIG. 3, proximate and distal flange end 41a, 41b associated with the upper flange 38a presents the elongated channel 36 which is configured for at least partial passage of the fastener 39.

In general, each channel 36 is configured generally for slidable receipt of a fastener 39 partially passing through the channel 36 allowing for vertical adjustment of the receiver 14 along the sidewall 7 of the trailer 6. In the depicted embodiment, each elongated channel 36 has a pair of substantially parallel sides presenting the elongated channel 36 with an inner dimension (D) greater than the outer dimension of the shaft 39a of the fastener 39 the inner dimension is less than the head 39b for partially passage of the fastener 39 through the channel 36. The elongated channel 36 allows for vertical adjustment of the receiver 14 through slideable engagement of the partially received fasteners 39.

The depicted embodiment of the lower flange 38b in FIG. 3 is generally rectangularly planar and includes at least one fastener receiver 37 which is configured for at least partial passage of the fastener 39. In general, each fastener receiver 37 is configured for partial passage of the fastener 39 for fastening the receiver along the sidewall 7 of the trailer 6. In contrast to the channel 36, the fastener receiver 36 limits vertical adjustment of the receiver 14 along the sidewall 7. In alternative embodiments, the upper and lower flange could provide for vertical adjustments or limit vertical adjustments, as desired.

Although there are numerous possible fasteners which one skilled in the art would readily recognize, in one embodiment each fastener 39 includes a shaft 39a extending from a head 39b, the shaft 39a being at least partially threaded.

An embodiment of the fastening pin 26 is illustrated in FIG. 3. The fastening pin 26 aligns and secures the support 20 within the receiver 14. As depicted, the fastening pin 26 is received within a side aperture 27 associated with the receiver 14. Generally, the side aperture 27 is configured for receipt of a portion of the fastening pin 26 extended through the receiver and the support 20. Although other embodiments may be utilized as understood by one skilled in the art, the depicted embodiment of the fastening pin 26 includes a circumferential groove 26b extending between a frustoconical head 26a and a cylindrical shaft 26c. In one embodiment, the fastening pin 26 may also include a handle 26d angularly extended from the cylindrical shaft 26c. it will be understood that the fastening pin 26 could be formed in various different configurations in accordance with the principles of the present disclosure. For example, the fastening pin head 26a may have a different shaped configuration and the fastening pin handle 26d may have a contoured or alternative shape for grabbing or extending the fastening pin 26 outwardly from the receiver 14.

Located opposite and in alignment with the fastening pin 26 on one of the opposite sides 14a is a fastening pin receiver 28. In general, the fastening pin 26 and fastening pin receiver 28 form a locking assembly 50 which maintains the support leg 20 in the desired position for orientation of the trailer 6 between the retracted or moveable position and the extended or parked position illustrated in FIG. 6. The fastening pin receiver 28 generally provides a complementary structure for secured receipt of the fastening pin 26 as it extends through the receiver 14. The fastening pin receiver 28 is generally configured for secured receipt of the frustoconical head 26a. In one embodiment, the fastening pin receiver 28 generally includes a keyed mechanism 29a configured for operation with a key 29b. In operation, the keyed mechanism 26a secures the fastening pin receiver 28 during operation, thereby controlling release of the fastening pin 26 from the fastening pin receiver 28. Alternatively, the keyed mechanism may include an alternative fastening mechanism to provide for secured and limited access to remove the fastening pin 26 from the fastening pin receiver such as, but not limited to, a combination locking mechanism as desired.

As depicted in FIG. 3, the receiver 14 is secured to the sidewall with at least one mounting bracket 30. In one embodiment of the present disclosure, the mounting bracket 30 may be attached directly to the trailer sidewall 7, the trailer support member 4 or indirectly through additional connectors to allow the support leg to extend downwardly with respect to the receiver 14. Additionally, the mounting bracket 30 may be removably or substantially fixedly attached to the trailer sidewall 7.

The embodiment of the depicted mounting bracket 30 in FIGS. 2-3 is configured for secured receipt of the fasteners 39 through a first tubular support 30a separated by a second tubular support 30b by the sidewall 7 and secured with a backing plate 30c which is secured to the fasteners 39 with a pair of mechanical fasteners 30d.

As further illustrated, the receiver in FIG. 3 includes a shroud plate 40, also referred to herein as a security plate, which protects the fastening pin 20 and locking mechanism 28. In one embodiment, the shroud plate 40 extends from a shroud front 42 to a shroud rear 44 as an elongated rectangular plate which may be fabricated from a hardened metal material such as hardened steel which is difficult to remove or damage. The shroud plate 40 generally, at least partially inhibits cutting, grinding or damaging the fastening pin 20 and/or the locking mechanism 28. In the depicted embodiment, the shroud front 42 extends outwardly from the receiver 14 to at least partially protect the locking pin 26. The shroud rear 44 at least partially extends outwardly from the receiver 14 opposite the shroud front 42 to at least partially protect the pin receiver 28. In this way, the shroud plate 40 protects the locking assembly 50 to help maintain the support leg 20 in the extended position so that the trailer can be pivoted downward to the parked position, for example. One embodiment of the shroud plate 40 is depicted in FIG. 3, attached to the front and extending outwardly from the receiver 14 at least partially overlying the fastening pin 26 and the fastening pin receiver 28.

FIGS. 4 and 5 illustrates an embodiment of an optional front wheel 12 which is sometimes referred to as a front vertical assembly 12 which includes a wheel 12a (also known as a jockey wheel), which may be used to raise or lower the tongue 8 of trailer 6. For example, the front vertical assembly 12 may be used to lower the wheel 12a to support the tongue 8 when the trailer 6 is decoupled from a vehicle. Conversely, the front vertical assembly 12 may be used to raise the wheel 12a when the hitch 9 is coupled to a vehicle (not shown) and thereby supported by the vehicle.

It should be understood that while certain forms of this invention have been illustrated and described, it is not limited thereto except insofar as such limitations are included in the following claims.

What is claimed and desired to be secured by Letters Patent:

1. An improved trailer lock in association with a trailer having a sidewall extending upwardly from a support member extending from a tongue, said trailer lock comprising:
at least one extendable support leg a receiver configured for slidable receipt of one of said extendable support leg;
at least one mounting bracket for mounting said receiver to at least one of said sidewall and said support member;
a locking mechanism for adjustably securing said extendable support leg to said receiver,
whereby operation of said extendable support leg rotates said trailer between a moveable position with said support member being horizontally orientated and a parked position with said tongue being rotated downward.

2. An improved trailer locking device configured for limiting movement of a trailer, said improved trailer locking device comprising:
an extendable support having a cross-section;
a receiver having a complementary cross-section configured for slidable receipt of said extendable support;
a fastening pin configured for at least partially passage through at least one side of said receiver and at least partially though said extendable support;
said fastening mechanism configured for engagement with said fastening pin;
an upper support spaced from a lower support said upper support and said lower support configured for mounting said receiver in a vertical position;
one of said upper support and said lower support configured for vertical adjustment of said receiver; and
a security plate mounted on said receiver and configured to at least partially obscure said fastening pin.

3. The improved trailer lock of claim 2 wherein one of said upper support and said lower support includes a channel configured for slideable receipt of a fastener whereby said receiver is vertically adjustable.

4. The improved trailer lock of claim 2 wherein said fastening pin includes a frustoconical head configured for receipt by said complementary fastening mechanism.

5. A method for rotating a trailer with a support extending from a proximate end to a distal end from a moveable position to a parked position whereby movement of the trailer is limited, said method comprising the steps of:
providing an improved locking device in communication with said support, said improved locking device configured for association with the trailer, said improved locking device comprising:
an extendable support operable for upward and downward movement;
a receiver configured for slidable receipt of said extendable support;
a fastening pin;
a fastening mechanism configured for at least partial receipt of said fastening pin;
an upper support; and
a lower support;
configuring said upper support and said lower support for securing said improved locking device near said distal end in relation to a ground surface whereby operation of said improved locking device at said distal end causes said extendable support to rotate said proximal end whereby movement of said trailer is at least partially limited;
extending said extendable support at least partially through said receiver;
aligning a pin receiver associated with said extendable support within said receiver for at least partial receipt of said fastening pin;
extending said fastening pin at least partially through said receiver;
securing said fastening pin at least partially by said fastening mechanism; and
associating a shroud plate with said fastening mechanism wherein said shroud plate at least partially limits damage to said improved locking device.
